(19) United States
(12) Patent Application Publication
(10) Pub. No.: US 2012/0006019 A1
(43) Pub. Date: Jan. 12, 2012

(54) INTERNAL COMBUSTION ENGINE WITH HORIZONTALLY ARRANGED CYLINDER BANKS AND EXHAUST-GAS TURBOCHARGER

(75) Inventors: Thomas Laube, Leonberg (DE); Michael Wessels, Bietigheim-Bessingen (DE); Frank Maier, Weissach (DE)

(73) Assignee: Dr. Ing. h.c. F. Porsche Aktiengessellschaft, Stuttgart (DE)

(21) Appl. No.: 13/177,068

(22) Filed: Jul. 6, 2011

(30) Foreign Application Priority Data
Jul. 8, 2010 (DE) 102010036303.0

(51) Int. Cl. F02B 37/00

(52) U.S. Cl. 60/605.1

(57) ABSTRACT

Disclosed herein is an internal combustion engine having horizontally arranged cylinder banks which are arranged on remote sides of a crankcase, which accommodates a crankshaft, of the internal combustion engine, and also having at least one exhaust-gas turbocharger with exhaust-gas turbocharger shaft. In an internal combustion engine of this type, it is provided that the at least one exhaust-gas turbocharger is arranged above the crankcase, and the axis of the exhaust-gas turbocharger shaft is arranged so as to be aligned horizontally and at 90° to the crankshaft axis. An internal combustion engine of this type has particularly good thermodynamic characteristics while being of compact design.

### CROSS-REFERENCE TO RELATED APPLICATION

This U.S. patent application claims priority to German Patent Application DE 10 2010 036 303.0, filed Jul. 8, 2010, which is incorporated by reference herein in its entirety.

### FIELD OF THE INVENTION

The invention relates to an internal combustion engine having horizontally arranged cylinder banks which are arranged on remote sides of a crankcase, which accommodates a crankshaft, of the internal combustion engine, and also having at least one exhaust-gas turbocharger with exhaust-gas turbocharger shaft.

### BACKGROUND OF THE INVENTION

A highly effective measure for reducing fuel consumption and CO₂ emissions has proven to be a reduction in swept volume in conjunction with supercharging of the internal combustion engine, so-called downsizing. In particular in interaction with gasoline direct injection, it is possible here to generate considerable possible savings. This is achieved by means of reduced internal friction, shifting the operating point into higher load ranges (dethrottling) and not least by reducing the assembly weight as a result of smaller swept volumes and/or a reduced number of cylinders.

In the case of boxer engines, it is generally the case that the exhaust-gas mass flows of in each case one cylinder bank are merged and supplied to in each case one turbine. Exhaust-gas-turbocharged boxer engines are consequently generally bi-turbo concepts. Here, an exhaust-gas turbocharger which is assigned to one cylinder bank is arranged on one side of the boxer engine and the other exhaust-gas turbocharger which is assigned to the other cylinder bank is arranged on the other side of the boxer engine. The exhaust-gas turbochargers are therefore positioned to the sides of the crankcase. Here, the axes of the exhaust-gas turbocharger shafts of the exhaust-gas turbochargers are arranged parallel to the axis of the crankshaft.

Concepts having only one exhaust-gas turbocharger can be thermodynamically advantageous, in particular if the single exhaust-gas turbocharger is equipped with variable turbine geometry. Maintaining the conventional arrangement entails in principle the omission of one exhaust-gas turbocharger. As a result, the exhaust gases of one cylinder bank must be conducted to the opposite side. Said principle is used in the prior art, but on account of the asymmetry and the consequently very significantly different running lengths between the left-hand and right-hand cylinder banks, this is associated with not inconsiderable thermodynamic disadvantages, which lead to reduced exhaust-gas turbocharger efficiency and therefore to reduced efficiency of the internal combustion engine. Said disadvantages include in particular losses in pulse supercharging as a result of long line lengths, losses in exhaust-gas enthalpy as a result of heat transfer in the long lines, and uneven air efficiencies of the different cylinders, and also the disadvantage of the increased introduction of heat into the engine bay as a result of long running lengths.

GB 369033, which is incorporated by reference, discloses a boxer engine in which an exhaust-gas turbine is arranged above the engine and a compressor is arranged below the boxer engine.

DE 11 2006 001 468 T5, which is incorporated by reference, describes an internal combustion engine in a V configuration, in which an exhaust-gas turbocharger is arranged above the engine. The axis of the exhaust-gas turbocharger shaft is arranged parallel to the axis of the crankshaft.

Furthermore, U.S. Pat. No. 2,858,666 and JP 2000 328951 A, which are each incorporated by reference, disclose V-engines in which an exhaust-gas turbocharger is arranged above the engine, wherein the axis of the exhaust-gas turbocharger shaft is arranged vertically and perpendicular to the axis of the crankshaft, and parallel to the axis of the crankshaft, respectively.

### SUMMARY OF THE INVENTION

It is an object of the present invention to refine an internal combustion engine of the type mentioned in the introduction such that it has particularly good thermodynamic characteristics while being of compact design.

The object is achieved in that the at least one exhaust-gas turbocharger is arranged above the crankcase, the axis of the exhaust-gas turbocharger shaft being arranged so as to be aligned horizontally and at an angle of between 75° and 105°, preferably 90°, with respect to the crankshaft axis.

The internal combustion engine preferably has horizontally arranged cylinder banks arranged on remote sides of the crankcase which accommodates the crankshaft. This makes it possible for the exhaust lines to be merged over as short a path as possible, and in particular for the arrangement of the exhaust system of one cylinder bank to be configured correspondingly to the arrangement of the exhaust system of the other cylinder bank. Since the at least one exhaust-gas turbocharger is arranged above the crankcase, it is possible to realize an internal combustion engine which is of relatively compact construction proceeding from the crankshaft in the direction of the cylinder banks.

According to aspects of the invention, it is also provided that the axis of rotation of the turbine and compressor of the at least one exhaust-gas turbocharger, and therefore the exhaust-gas turbocharger shaft, be arranged so as to be aligned horizontally and at an angle with respect to the crankshaft axis of the internal combustion engine, the angle being between 75° and 105° or between 80° and 100°, and preferably being 90°. Said arrangement contributes significantly to the compact design of the internal combustion engine, and permits in a particularly simple manner the symmetrical connection of the exhaust tracts while providing a short structural length of the assembly.

It is preferable for only a single exhaust-gas turbocharger to be provided. It is however by all means possible to use a plurality of exhaust-gas turbochargers, in particular two exhaust-gas turbochargers, which are arranged above the crankcase. Systems that can be switched using suitable valves, in which flow passes through only one exhaust-gas turbocharger in the lower load and rotational speed range and flow passes through both exhaust-gas turbochargers in the upper load and rotational speed range, can be realized with both arrangements. These may be designed as multi-stage supercharging, sequential supercharging or switched parallel-twin supercharging concepts.

In general, the at least one exhaust-gas turbocharger is arranged above the crankcase at the flywheel side thereof, where a transmission is connected to the end side of the crankcase. On that side of the internal combustion engine which faces away therefrom, that is to say on the belt side of the engine, there therefore remains a sufficient amount of installation space for auxiliary assemblies such as a generator, high-pressure pump and refrigerant compressor to be kept at said location. The advantage of said arrangement is that, for an exhaust-gas turbocharger/catalytic converter pack, it is possible to utilize the naturally relatively great width of the horizontal cylinders while simultaneously maintaining the short structural length. This results in an extremely compact assembly which is suitable for longitudinal installation even in vehicles with a short engine bay, for example compact cars and mid-engined vehicles. It is basically conceivable for the exhaust-gas turbocharger to be arranged on the belt side of the assembly rather than on the flywheel side. For said variant, this basically requires additional thermal insulation of the belt drive. Furthermore, when relocating the exhaust-gas turbocharger to the belt side of the crankcase, it is necessary for the auxiliary assemblies to be arranged differently, for example on the underside of the crankcase.

It is considered to be particularly advantageous if an exhaust-gas purification device, in particular an exhaust-gas catalytic converter, is arranged adjacent to the at least one exhaust-gas turbocharger. In particular, with respect to a plane running vertically through the crankshaft axis, the at least one exhaust-gas turbocharger is arranged adjacent to said plane and the exhaust-gas purification device is arranged adjacent to said plane on the opposite side of the plane from the exhaust-gas turbocharger. The exhaust lines of the respective cylinder bank are merged to form an exhaust line, and said two exhaust lines of the cylinder banks are merged in particular in the region of the plane running through the crankshaft axis. The turbine is then provided on that side of the exhaust-gas turbocharger which faces toward said plane. The turbine inlet is preferably positioned on the crankshaft axis or at least close to the crankshaft axis, such that the exhaust lines of the cylinder banks or the exhaust manifolds of the cylinder banks can be designed symmetrically.

On account of the close-coupled arrangement of the exhaust-gas purification device, it can reach its operating temperature quickly.

The exhaust lines are preferably merged over as short a path as possible and introduced into the turbine of the exhaust-gas turbocharger. This ensures good response behavior of the exhaust-gas turbocharger. The exhaust lines run preferably symmetrically and are preferably formed with equal running lengths. This makes it possible to utilize pulse supercharging on account of the short lines, and furthermore equal air efficiencies for all the cylinders are ensured, and finally the short lines result in low heat losses, with the result being a fast warm-up of the exhaust-gas purification device.

According to a particularly preferred refinement of the invention, it is provided that, in the case of an internal combustion engine in which the cylinder heads assigned to the cylinder banks are provided with inlet ducts and outlet ducts, the inlet ducts are arranged at the bottom and the outlet ducts are arranged at the top. Since the outlet ducts are likewise relocated to the top side of the engine, the exhaust lines can be kept particularly short. The throughflow direction of the cylinder heads is therefore reversed. The intake side is relocated to the underside of the internal combustion engine. In principle, the cylinder head construction with the ducts and the entire timing mechanism is mirror-inverted about a z-plane through the crankshaft axis. A corresponding redesign of the water jacket and an adaptation of the crankcase are necessary. Thermodynamically, this does not result in any disadvantages for the internal combustion engine.

The internal combustion engine serves in particular for the drive of a vehicle, in particular a land vehicle. On account of the arrangement according to aspects of the invention, the hot components, in particular the exhaust manifold, the exhaust-gas turbocharger and the catalytic converter, are no longer situated on the underside of the engine, where they are subjected to efficient convection cooling by the relative wind acting on the vehicle. In fact, a situation is obtained in which the heat introduced in the engine bay by said components primarily by radiation will build up. It therefore cannot be ruled out that existing scavenging blowers and the relative wind flow through the engine bay are not sufficient to dissipate said amount of heat. There is therefore the risk of the limit temperature for various plastic components in the engine bay, for example electrical lines and control units, being exceeded.

For this reason, according to a preferred refinement of the invention, the hot components are provided with insulation. Accordingly, the exhaust manifold, exhaust-gas turbocharger and exhaust-gas purification device at the outlet pipe thereof are thermally insulated to the outside. The thermal insulation is formed in particular as integral insulation, having an air gap which is sealed off in the direction of the hot components and having a scavenging blower for conducting air through the air gap. Said integral insulation is formed so as to be approximately air-tight, and the air gap is actively ventilated by means of the scavenging blower in order to realize convection cooling. Here, the supply air is preferably picked off at a suitable point on the outside of the vehicle, ideally in the region of an aerodynamic positive pressure zone. The cooling or scavenging air flows through the air gap and, in so doing, cools the hot parts. Said air exits the air gap in the region of the underside of the body, ideally in the region of a negative pressure zone. The active cooling is assisted by the vehicle aerodynamics on account of the positive pressure gradient obtained in this way during driving operation.

The internal combustion engine is designed in particular as a boxer engine or as a 180° V-engine. The internal combustion engine generally has two cylinder banks.

Further features of the invention will emerge from the subclaims, from the appended drawing and from the description of the exemplary embodiment depicted in the drawing, without the invention being restricted to said exemplary embodiment.

### BRIEF DESCRIPTION OF THE DRAWING FIGURES

In the drawing, in each case schematically:

FIG. 1 shows an end view of the internal combustion engine according to aspects of the invention,

FIG. 2 shows a plan view of the internal combustion engine illustrated in FIG. 1,

FIG. 3 shows a basic illustration of integral insulation.

### DETAILED DESCRIPTION OF THE PREFERRED EMBODIMENTS

The internal combustion engine, which is designed as a boxer engine 1, has two horizontally arranged cylinder banks 2 and 3 with in each case three cylinders. The cylinder banks 2 and 3 are arranged on remote sides of a crankcase 4 which accommodates a crankshaft. The crankshaft axis is illustrated by dash-dotted lines and is denoted by the reference numeral 5. Connected to the end side of the crankcase 4 is a transmission; in physical terms, a transmission bell 6 is connected to an end side of the crankcase 4. Said side of the boxer engine 1 therefore constitutes its flywheel side. Situated at the other end of the crankcase 4 is the belt side of the boxer engine 1, illustrated by a belt pulley 7 which is connected to, so as to rotate conjointly with, that end of the crankshaft 8 which faces toward it. An oil pan 9 is connected to the crankcase 4 in the lower region of the latter.

Arranged above the crankcase 4 and adjacent to the transmission bell 6 is an exhaust-gas turbocharger 10 and, adjacent to the latter, an exhaust-gas purification device designed as an exhaust-gas catalytic converter 11.

The exhaust-gas turbocharger shaft 12, and therefore the axis of rotation of the rotors of the turbine 13 and compressor 14 of the exhaust-gas turbocharger 10, is arranged horizontally, and therefore substantially level, but extends at an angle of 90° with respect to the crankshaft axis 5. With respect to a plane running vertically through the crankshaft axis 5, the exhaust-gas turbocharger 10 is arranged adjacent to said plane on the side of the cylinder bank 2, and the exhaust-gas catalytic converter 11 is arranged adjacent to said plane on the side assigned to the other cylinder bank 3. The turbine 13 is arranged adjacent to said plane, and the compressor 14 is arranged at a greater distance from said plane. The inlet of the turbine 13 is preferably positioned on the crankshaft axis 5 or as close as possible to the crankshaft axis 5, such that the collecting lines 16 of the cylinder banks 2 and 3 may be of symmetrical design; that is to say, there are approximately equal spacings from the turbine inlet to the respective collecting line.

Proceeding from the three cylinders of the respective cylinder bank 2 or 3, the three exhaust lines 15 thereof are merged, specifically are arranged symmetrically up to their common collecting line 16, whereby the two outer exhaust lines 15 have the same line length and also the middle exhaust line 15 preferably has a corresponding length. The identical two collecting lines 16 of the two cylinder banks 2 and 3 are merged, in the region of the plane which runs vertically through the crankshaft axis 5, to form a collecting line 17 which is connected, over a short path, to the turbine 13 of the exhaust-gas turbocharger 10. The exhaust gas exits the turbine 13 through the line 18 and passes, over a short path, to the exhaust-gas catalytic converter 11 and from there into is the discharge line 19.

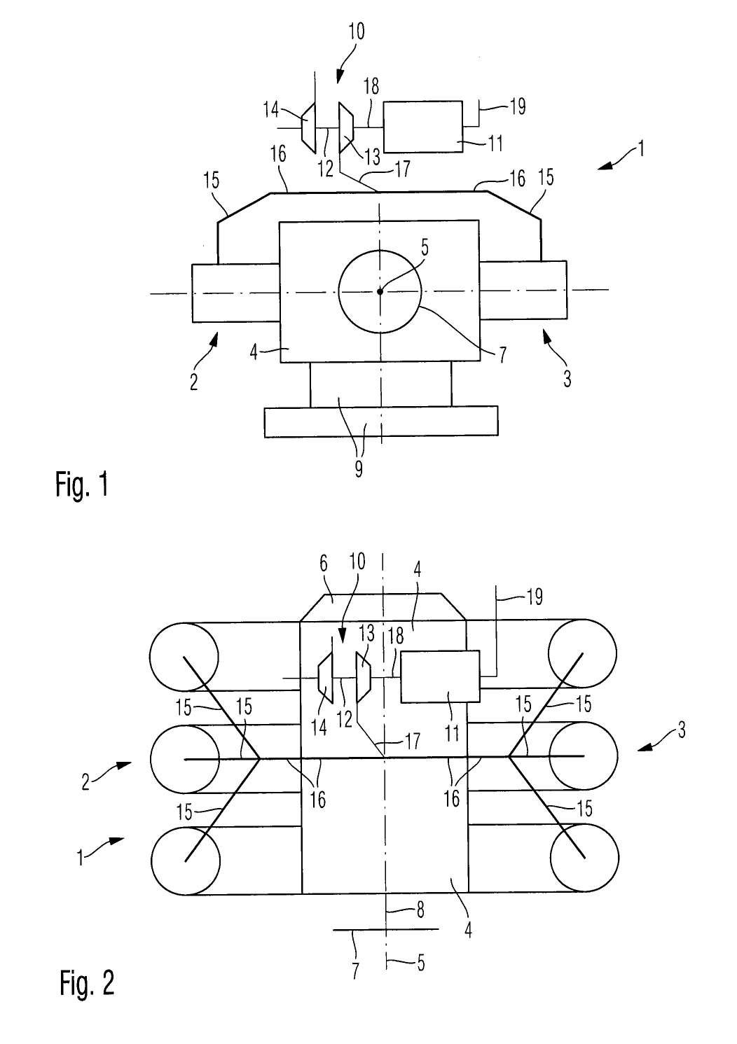

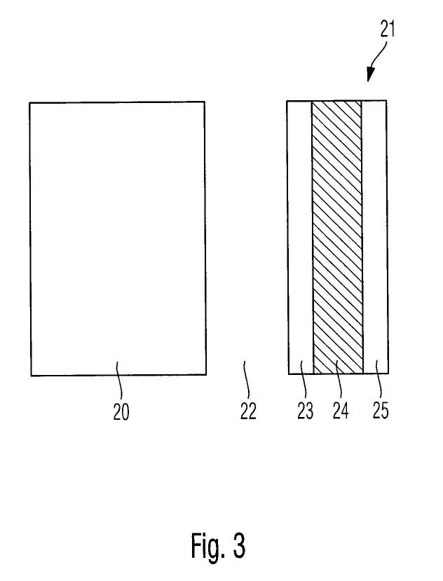

As is shown in the embodiment according to FIGS. 1 and 2, the hot components of the exhaust manifold, exhaust-gas turbocharger and catalytic converter are no longer situated on the underside of the engine, where they are subjected to efficient convection cooling by the relative wind if the internal combustion engine is installed in a vehicle. Accordingly, the hot components must be provided with insulation, as is basically shown in FIG. 3 for integral insulation such as is known per se: the Figure shows, for a short length of the insulation, a hot component 20 illustrated over said short length, which component is surrounded by an insulation 21, with an air gap 22 being formed between said insulation 21 and the hot component 20. Said insulation 21 is likewise shown only over the stated short length. The insulation 21 has, on the side facing toward the air gap 22, a radiation shield 23, which is for example a sheet-metal part. On the side facing away from the air gap 22, the radiation shield 23 is provided with mineral fiber insulation 24, and the latter is provided, on the side facing away from the air gap 22, with a radiation shield 25 or jacket for protecting the fibers of the fiber insulation 24. The described integral insulation is designed to be approximately air-tight, and is actively ventilated by a scavenging blower (not shown) in order to obtain convection cooling. Here, the supply air is picked off at a suitable location on the outside of the vehicle, ideally in the region of an aerodynamic positive pressure zone. The cooling or scavenging air flows through the air gap 22 and, in so doing, cools the hot component 20. The air exits the air gap 22 in the region of the underside of the body, ideally in the region of a negative pressure zone. The active cooling is assisted by the vehicle aerodynamics on account of the positive pressure gradient obtained in this way during driving operation.

### LIST OF REFERENCE NUMERALS

1 Boxer engine
2 Cylinder bank
3 Cylinder bank
4 Crankcase
5 Crankshaft axis
6 Transmission bell
7 Belt pulley
8 Crankshaft
9 Oil pan
10 Exhaust-gas turbocharger
11 Exhaust-gas purification device/exhaust-gas catalytic converter
12 Exhaust-gas turbocharger shaft
13 Turbine
14 Compressor
15 Exhaust line
16 Collecting line
17 Collecting line
18 Line
19 Discharge line
20 Hot component
21 Insulation
22 Air gap
23 Radiation shield
24 Fiber insulation
25 Radiation shield

1.-15. (canceled)

16. An internal combustion engine comprising: a crankcase and a crankshaft accommodated in said crankcase, and at least one exhaust-gas turbocharger with an exhaust-gas turbocharger shaft, wherein the at least one exhaust-gas turbocharger is arranged above the crankcase, an axis of the exhaust-gas turbocharger shaft is arranged so as to be aligned horizontally and at an angle with respect to an axis of the crankshaft, the angle being between 75° and 105° or between 80° and 100°.

17. The internal combustion engine as claimed in claim 16, wherein the internal combustion engine has horizontally arranged cylinder banks arranged on remote sides of the crankcase which accommodates the crankshaft.

18. The internal combustion engine as claimed in claim 16 further comprising a single exhaust-gas turbocharger.

19. The internal combustion engine as claimed in claim 16 further comprising two or more exhaust-gas turbochargers.

20. The internal combustion engine as claimed in claim 16, wherein the internal combustion engine is a boxer engine or a 180° V-engine.

21. The internal combustion engine as claimed in claim 16, wherein the internal combustion engine has two cylinder banks.

22. The internal combustion engine as claimed in claim 16, wherein a transmission is connected to an end side of the crankcase, and the at least one exhaust-gas turbocharger is arranged adjacent to the transmission.

23. The internal combustion engine as claimed in claim 16, wherein the internal combustion engine is assigned an exhaust-gas purification device which is arranged adjacent to the at least one exhaust-gas turbocharger.

24. The internal combustion engine as claimed in claim 23, wherein, with respect to a plane running vertically through the crankshaft axis, the at least one exhaust-gas turbocharger is arranged adjacent to said plane and the exhaust-gas purification device is arranged adjacent to said plane on the opposite side of the plane from the exhaust-gas turbocharger.

25. The internal combustion engine as claimed in claim 23, wherein the exhaust-gas purification device is an exhaust-gas catalytic converter.

26. The internal combustion engine as claimed in claim 23, wherein a pack formed from at least one exhaust-gas turbocharger and the exhaust-gas purification device is arranged on a flywheel side of the internal combustion engine.

27. The internal combustion engine as claimed in claim 23, wherein an exhaust manifold of the engine, the exhaust-gas turbocharger, the exhaust-gas purification device and an outlet pipe of the exhaust-gas purification device are thermally insulated to the outside.

28. The internal combustion engine as claimed in claim 27 further comprising integrally formed thermal insulation, a sealed air gap between hot components and the insulation, and a scavenging blower for conducting air through the air gap.

29. The internal combustion engine as claimed in claim 28, wherein scavenging air is branched off in a region of an aerodynamic positive pressure zone on the outside of a vehicle provided with the internal combustion engine.

30. The internal combustion engine as claimed in claim 16, wherein an arrangement of an exhaust system of one cylinder bank of the engine is configured correspondingly to an arrangement of an exhaust system of another cylinder bank of the engine.

31. The internal combustion engine as claimed in claim 16, wherein the internal combustion engine has cylinder heads which are assigned to cylinder banks of the engine and which have inlet ducts and outlet ducts, the inlet ducts being arranged at the bottom and the outlet ducts being arranged at the top.
